(19) United States
(12) Patent Application Publication
(10) Pub. No.: US 2018/0210578 A1
(43) Pub. Date: Jul. 26, 2018

(54) TOUCH SENSOR AND COMPUTER MOUSE INCLUDING THE SAME

(71) Applicant: Samsung Display Co., Ltd., Yongin-si (KR)

(72) Inventors: Byeong Hee Won, Yongin-si (KR); Mu Gyeom Kim, Yongin-si (KR); Kyung Tea Park, Yongin-si (KR); Eun Jin Sung, Yongin-si (KR)

(21) Appl. No.: 15/879,387

(22) Filed: Jan. 24, 2018

(30) Foreign Application Priority Data
Jan. 24, 2017 (KR) 10-2017-0011095

(51) Int. Cl. G06F 3/044; G06F 3/0354

(52) U.S. Cl. CPC G06F 3/044; G06F 3/03544

(57) ABSTRACT

A touch sensor includes a substrate, a base layer, and sensor pixels. The base layer has first patterns arranged on the substrate and second patterns coupled between the first patterns. The sensor pixels are disposed on the first patterns and configured to sense a touch of a user depending on a change in capacitance associated with a corresponding sensor pixel. A computer mouse incorporating touch sensors also is disclosed.

### CROSS-REFERENCE TO RELATED APPLICATION

This application claims priority from and the benefit of Korean Patent Application No. 10-2017-0011095, filed on Jan. 24, 2017, which is hereby incorporated by reference for all purposes as if fully set forth herein.

### BACKGROUND

### FIELD

The invention relates generally to a touch sensor and a mouse including the same, and more particularly, to a deformable touch sensor and a mouse including the same.

### DISCUSSION OF THE BACKGROUND

A touch sensor may use various methods to recognize a touch input, such as an optical method, a thermal sensing method and a capacitive method. A capacitive touch sensor may detect a point at which capacitance is changed depending on a touch of an object such as the hand of a user and thus determine the location of the touch point. The capacitive touch sensor easily detects multiple touches and has excellent precision; therefore, recently, it has been widely used.

Recently, touch sensors have been used to detect not only the location of a touch but also a fingerprint and pressure applied by the touch, thus providing various functions to users.

The capacitive touch sensor for detecting a fingerprint may obtain the fingerprint (or fingerprint pattern) by detecting a change in capacitance depending on the shapes of a valley and a ridge of the fingerprint as the finger of the user approaches the capacitive touch sensor.

The above information disclosed in this Background section is only for enhancement of understanding of the background of the inventive concepts, and, therefore, it may contain information that does not form prior art.

### SUMMARY

Touch sensors constructed according to the principles of the invention are capable of being deformed without creating defects that could affect the accuracy or sensitivity of the touch sensor. Touch sensors and a computer mouse including the same constructed according to the principles of the invention are capable of effectively sensing a fingerprint of a user.

Additional aspects will be set forth in the detailed description which follows, and, in part, will be apparent from the disclosure, or may be learned by practice of the inventive concepts.

According to one aspect of the invention, a touch sensor includes: a substrate; a base layer having first patterns arranged on the substrate and second patterns coupled between the first patterns; and sensor pixels disposed on the first patterns and configured to sense a touch of a user depending on a change in capacitance associated with a corresponding sensor pixel.

The touch sensor may further include sensor scan lines and output lines coupled to the sensor pixels. Among the sensor pixels, a sensor pixel coupled to an i-th sensor scan line selected from the scan lines and a j-th output line selected from the output lines may include: a sensor electrode; a first transistor having a gate electrode coupled to the sensor electrode, the first transistor being configured to control output current to be outputted through the j-th output line; a second transistor having a gate electrode coupled to the i-th sensor scan line, the second transistor being coupled between a reference voltage line and the first transistor; and a capacitor electrode configured to form a first capacitor with the sensor electrode, and coupled to the i-th sensor scan line, wherein i is an integer equal to or greater than 2 and j is a natural number.

The sensor pixel may further have a third transistor including a gate electrode coupled to an i-1-th scan line, the third transistor being coupled between the reference voltage line and the sensor electrode.

The sensor electrode may form a second capacitor with a finger of the user.

The magnitude of the output current may vary depending on a change in capacitance of the second capacitor.

A gate voltage to be applied to the gate electrode of the first transistor may be defined by a following equation, Vg=Vcom+{Vc1/(Vc1+Vc2)}*Vs, where Vg denotes the gate voltage, Vcom denotes a reference voltage provided to the second transistor through the reference voltage line, Vc1 denotes a capacitance of the first capacitor, Vc2 denotes a capacitance of the second capacitor, and Vs denotes a change in voltage of a sensor scan signal provided through the i-th sensor scan line.

The touch sensor may further include a power supply unit configured to provide a reference voltage to the reference voltage line, a sensor scan driver configured to successively supply a sensor scan signal to the sensor scan lines, and a read-out circuit configured to detect a fingerprint using output current provided through the output lines.

The substrate may includes a touch sensing area and a peripheral area disposed around the touch sensing area. The base layer may be disposed on the touch sensing area, and at least one of the power supply unit, the sensor scan driver and the read-out circuit may be disposed on the peripheral area.

The sensor electrode may include a transparent conductive material.

The sensor electrode may overlap the capacitor electrode.

The touch sensor may further include signal lines coupled to the sensor pixels. The sensor pixels may be controlled through the signal lines. The signal lines may be disposed in the second patterns, and extend into the first patterns coupled to the sensor pixels.

Portions of the signal lines disposed in the second patterns may have a shape that accommodates deformation without creating defects in the signal lines.

The shape of portions of the signal lines disposed in the second patterns may include a shape having slack or curvature, and at least portions of the signal lines disposed on the first patterns may include linear shapes.

The first patterns may be in the form of island patterns and the second patterns may be in the form of bridge patterns.

According to another aspect of the invention, a computer mouse includes: a body; at least one button unit disposed on the mouse body and configured to receive an input from a user; and a touch sensor configured to sense a touch of the user to generate touch information.

The touch sensor includes: a substrate; a base layer including first patterns arranged on the substrate and second patterns coupled between the first patterns; and sensor pixels disposed on the first patterns configured to sense the touch of the user depending on a change in capacitance associated to a corresponding sensor pixel.

The touch sensor may further include sensor scan lines and output lines coupled to the sensor pixels. Among the sensor pixels, a sensor pixel coupled to an i-th sensor scan line selected from the scan lines and a j-th output line selected from the output lines may include: a sensor electrode; a first transistor having a gate electrode coupled to the sensor electrode, the first transistor being configured to control output current to be outputted through the j-th output line; a second transistor having a gate electrode coupled to the i-th sensor scan line, the second transistor being coupled between a reference voltage line and the first transistor; and a capacitor electrode configured to form a first capacitor with the sensor electrode, and coupled to the i-th sensor scan line, wherein i is an integer equal to or greater than 2 and j is a natural number.

The sensor pixel may further include a third transistor having a gate electrode coupled to an i-1-th scan line, the third transistor being coupled between the reference voltage line and the sensor electrode.

The sensor electrode may form a second capacitor with a finger of the user, and a magnitude of the output current may vary depending on a change in capacitance of the second capacitor.

The touch sensor may further include: a power supply unit configured to provide a reference voltage to the reference voltage line; a sensor scan driver configured to successively supply a sensor scan signal to the sensor scan lines; and a read-out circuit configured to detect a fingerprint using the output current provided through the output lines.

The touch sensor may be disposed in or on at least one of the body and the button unit, and the first patterns may be in the form of island patterns and the second patterns be in the form of bridge patterns.

According to the principles and exemplary embodiments of the invention, the touch sensor may include island patterns and the bridge patterns, and sensor pixels disposed on the island patterns. The touch sensor may be deformed without creating defects that could affect the accuracy or sensitivity of the touch sensor, such as disconnection of signal lines coupled to the sensor pixels. Therefore, the touch sensor may effectively sense a fingerprint of a user.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 is a block diagram illustrating an exemplary embodiment of a touch sensor constructed according to the principles of the invention.

FIG. 2 is a plan view illustrating an exemplary embodiment of one of the sensor pixels shown in FIG. 1.

FIGS. 3A and 3B are schematic diagrams illustrating capacitances formed between the sensor electrode and a finger, and between the capacitor electrode and sensor electrode, and the finger when a ridge (FIG. 3A) and a valley (FIG. 3B) of the finger is adjacent to the sensor electrode.

FIG. 4 is an equivalent circuit diagram illustrating an exemplary embodiment of the sensor pixel shown in FIG. 1.

FIG. 5 is a timing diagram illustrating exemplary sensor scan signals applied to the sensor pixel shown in FIG. 4.

FIG. 6 is a plan view illustrating an exemplary embodiment of a touch sensor including a touch sensing area and a peripheral area constructed according to the principles of the invention.

FIGS. 7A and 7B are plan views illustrating an exemplary embodiment of a base layer of a touch sensor shown in FIG. 6.

FIG. 8 is an enlarged view of a region P1 shown in FIG. 7B.

FIG. 9A is a perspective view illustrating an exemplary embodiment of a mouse including a touch sensor constructed according to the principles of the invention.

FIG. 9B is a side view illustrating the mouse shown in FIG. 9A.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

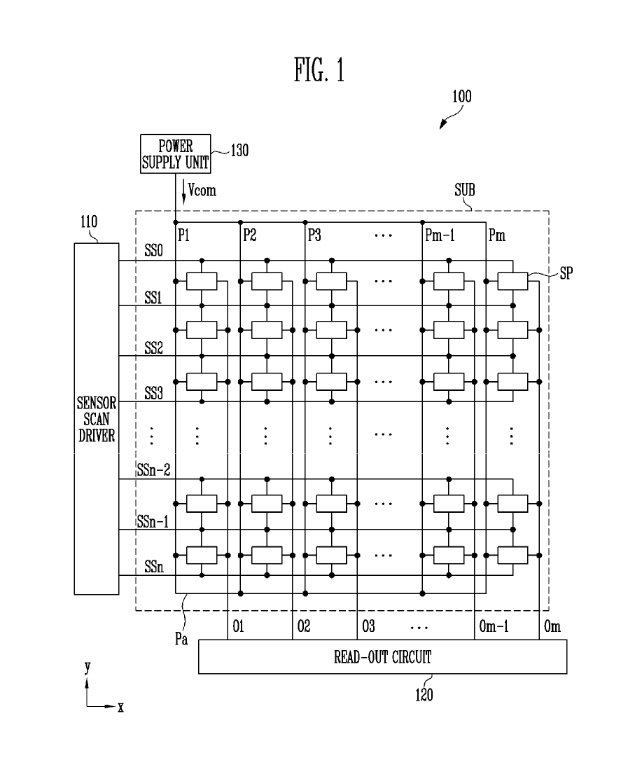

FIG. 1 is a block diagram illustrating an exemplary embodiment of a touch sensor constructed according to the principles of the invention.

Referring to FIG. 1, a touch sensor 100 may be touched by any suitable object, such as a finger of user. The touch sensor 100 may recognize the touch generated by a user. For example, recognition operations implemented by the touch sensor 100 may include at least one of an operation of identifying a location of the touch, an operation of recognizing the fingerprint of the touched finger, and an operation of sensing a pressure applied by the touch.

The touch sensor 100 may include a substrate SUB, a plurality of sensor pixels SP, a sensor scan driver 110, a read-out circuit 120 and a power supply unit 130.

The substrate SUB may be made of an insulating material such as glass or resin. Furthermore, the substrate SUB may be made of at least one of various suitable materials having flexibility so as to be deformable (e.g., bendable or foldable), and have a single layer or multilayer structure. For example, the substrate SUB may include at least one material selected from the group of polystyrene, polyvinyl alcohol, polymethyl methacrylate, polyethersulfone, polyacrylate, polyetherimide, polyethylene naphthalate, polyethylene terephthalate, polyphenylene sulfide, polyarylate, polyimide, polycarbonate, triacetate cellulose, cellulose acetate propionate, and similar materials. However, the material constituting the substrate 112 may be changed in various ways. For instance, the substrate 112 may also be made of fiber-reinforced plastic (FRP) or the like.

The sensor pixels SP may be disposed on the substrate SUB. The sensor pixels SP may be electrically coupled to signal lines, such as sensor scan lines SS0 to SSn and output lines O1 to Om. The sensor pixels SP may be addressable elements that may be controlled through the signal lines and may sense the location and/or magnitude of a touch input to perform the recognition operation(s).

The sensor pixels SP may receive sensor scan signals through the sensor scan lines SS0 to SSn. The sensor pixels SP receiving the sensor scan signal may output current whose magnitude is based on the amount of touch sensed (“touch state”) to the associated output lines O1 to Om.

The sensor scan lines SS0 to SSn may be disposed on the substrate SUB, and may extend in a first direction (e.g., an X-axis direction). The sensor scan lines SS0 to SSn may be coupled to the sensor pixels SP arranged in the first direction.

The output lines O1 to Om may be disposed on the substrate SUB, and may extend in a second direction (e.g., a Y-axis direction). The output lines O1 to Om may be coupled to the sensor pixels SP arranged in the second direction.

The sensor pixels SP may be coupled to reference voltage lines P1 to Pm, and may be supplied with a reference voltage Vcom through the reference voltage lines P1 to Pm. The reference voltage lines P1 to Pm may extend in the second direction and be coupled to the sensor pixels SP arranged in the second direction. For example, the reference voltage lines P1 to Pm may be arranged in parallel to the output lines O1 to Om. However, the arrangement direction of the reference voltage lines P1 to Pm may be changed in various forms, and the reference voltage lines P1 to Pm may be arranged in parallel to, for example, the sensor scan lines SS0 to SSn.

The reference voltage lines P1 to Pm may be electrically coupled to each other in order to have the same potential. For example, the reference voltage lines P1 to Pm may be electrically coupled to each other in the perimeter of the substrate SUB via a separate line Pa.

The sensor scan driver 110 may supply the sensor scan signals to the sensor pixels SP through the sensor scan lines SS0 to SSn. For example, the sensor scan driver 110 may sequentially output the sensor scan signals to the sensor scan lines SS0 to SSn. The sensor scan signals may have voltage levels able to turn on transistors which are supplied with the sensor scan signals.

For connection to the sensor scan lines SSo to SSn, the sensor scan driver 110 may be mounted on the substrate SUB or may be coupled to the substrate SUB by a separate component such as a flexible printed circuit board (FPCB).

The read-out circuit 120 may receive signals (e.g., output currents) output from the sensor pixels SP through the output lines O1 to Om. For example, when the sensor scan driver 110 sequentially supplies the sensor scan signals, the sensor pixels SP receiving the sensor scan signal through a corresponding sensor scan line may be selected, and the read-out circuit 120 may receive output currents from the selected sensor pixels SP. Here, the read-out circuit 120 may recognize touch information by sensing changes in the output currents.

For instance, the touch information may include at least one of the presence or absence of a touch detected by the touch sensor 100, the location of the touch, the pressure applied by the touch, and valleys and ridges included in a fingerprint.

For connection to the output lines O1 to Om, the read-out circuit 120 may be mounted on the substrate SUB, or may be coupled to the substrate SUB by a separate component such as a flexible printed circuit board.

The power supply unit 130 may supply the reference voltage Vcom to the sensor pixels SP through the reference voltage lines P1 to Pm.

For connection to the reference voltage lines P1 to Pm, the power supply unit 130 may be mounted on the substrate SUB, or may be coupled to the substrate SUB by a separate component such as a flexible printed circuit board.

While the sensor scan driver 110, the read-out circuit 120, and the power supply unit 130 in the illustrated embodiment are shown as being separately provided, exemplary embodiments are not limited thereto. At least some of the foregoing components may be integrated with each other if needed.

The sensor scan driver 110, the read-out circuit 120, and the power supply unit 130 may be installed using any one of various known methods, such as chip on glass, chip on plastic, tape carrier package, and chip on film methods.

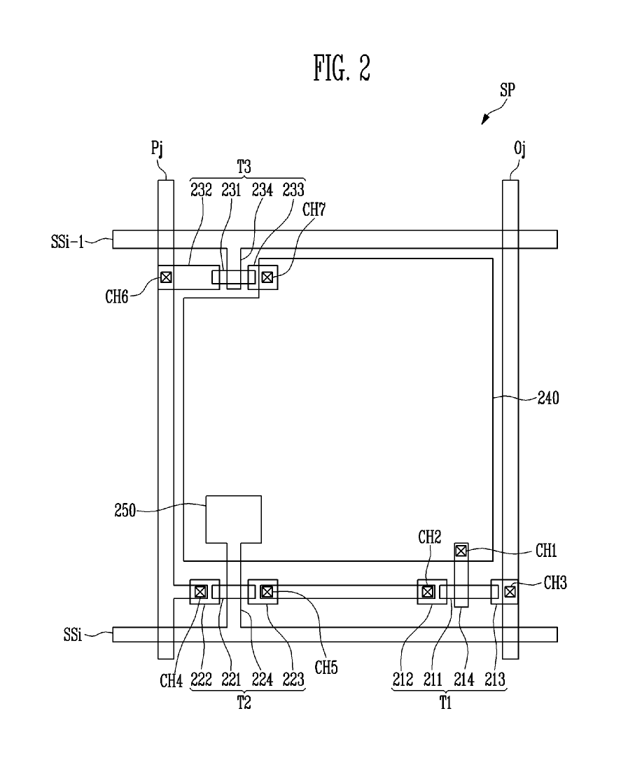

FIG. 2 is a plan view illustrating an exemplary embodiment of one of the sensor pixels shown in FIG. 1. For the sake of the description, a sensor pixel SP coupled to an i-th sensor scan line SSi and a j-th output line Oj is illustrated in FIG. 2 (where i is an integer equal to or greater than 2 and j is a natural number).

Referring to FIG. 2, the exemplary sensor pixel SP may include a sensor electrode 240, a first transistor T1, a second transistor T2, a third transistor T3, and a capacitor electrode 250.

The first transistor T1 may control an output current flowing to the j-th output line Oj. The first transistor T1 may be coupled between the j-th output line Oj and the second transistor T2. For example, the first transistor T1 may include a first electrode 212 coupled to a second electrode 223 of the second transistor T2, a second electrode 213 coupled to the j-th output line Oj, a gate electrode 214 coupled to the sensor electrode 240, and a semiconductor layer 211 coupled between the first electrode 212 and the second electrode 213. The gate electrode 214, the first electrode 212, and the second electrode 213 of the first transistor T1 may be coupled to other components through respective contact holes CH1, CH2, and CH3.

Therefore, the first transistor T1 may control an output current which is output to the j-th output line Oj in response to the potential of the sensor electrode 240.

The second transistor T2 may be coupled between a j-th reference voltage line Pj and the first transistor T1. For example, the second transistor T2 may include a first electrode 222 coupled to the j-th reference voltage line Pj, a second electrode 223 coupled to the first electrode 212 of the first transistor T1, a gate electrode 224 coupled to the i-th sensor scan line SSi, and a semiconductor layer 221 coupled between the first electrode 222 and the second electrode 223. The first electrode 222 and the second electrode 223 of the second transistor T2 may be coupled to other components through respective contact holes CH4 and CH5.

Therefore, the second transistor T2 may be turned on when the sensor scan signal is supplied to the i-th sensor scan line SSi. When the second transistor T2 is turned on, the reference voltage Vcom may be applied to the first electrode 212 of the first transistor T1.

The third transistor T3 may be coupled between the j-th reference voltage line Pj and the sensor electrode 240. For example, the third transistor T3 may include a first electrode 232 coupled to the j-th reference voltage line Pj, a second electrode 233 coupled to the sensor electrode 240, a gate electrode 234 coupled to the i-1-th sensor scan line SSi-1, and a semiconductor layer 231 coupled between the first electrode 232 and the second electrode 233. The first electrode 232 and the second electrode 233 of the third transistor T3 may be coupled to other components through respective contact holes CH6 and CH7.

Therefore, the third transistor T3 may be turned on when the sensor scan signal is supplied to the i-1-th sensor scan line SSi-1. When the third transistor T3 is turned on, the voltage of the sensor electrode 240 may be initialized to the reference voltage Vcom.

The capacitor electrode 250 may be disposed to overlap the sensor electrode 240, and may thus form a capacitor with the sensor electrode 240. At least one insulating layer may be disposed between the sensor electrode 240 and the capacitor electrode 250 to form the capacitor.

The capacitor electrode 250 may be coupled to the i-th sensor scan line SSi. For example, the capacitor electrode 250 may be coupled to the i-th sensor scan line SSi through the gate electrode 224 of the second transistor T2. The capacitor electrode 250 and the gate electrode 224 of the second transistor T2 may be made of the same material as that of the i-th sensor scan line SSi.

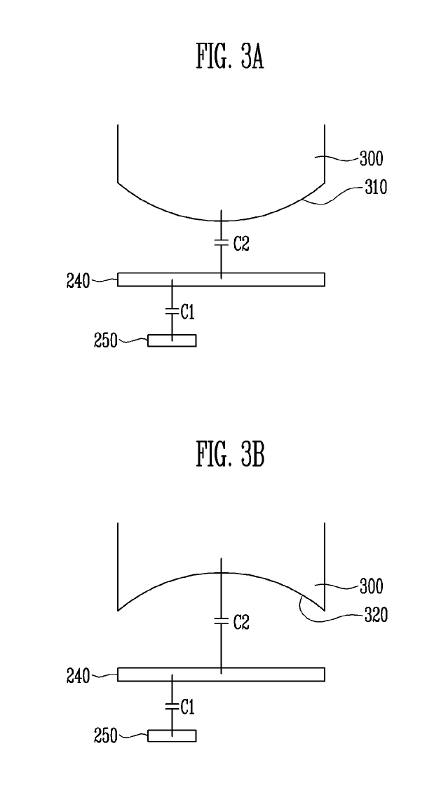

The sensor electrode 240 may form not only the capacitor with the capacitor electrode 250 but also a capacitor with the touched finger or the like. See FIGS. 3A-3B.

The sensor electrode 240 may include conductive material. For example, the conductive material may include at least material selected from the group of a metal, an alloy of metals, a conductive polymer, a transparent conductive material, and similar materials.

For instance, the metal may include at least one of copper, silver, gold, platinum, palladium, nickel, tin, aluminum, cobalt, rhodium, iridium, iron, ruthenium, osmium, manganese, molybdenum, tungsten, niobium, tantalum, titanium, bismuth, antimony, and lead.

For example, the conductive polymer may include at least one of a polythiophene compound, a polypyrrole compound, a polyaniline compound, a polyacetylene compound, a polyphenylene compound, and mixtures thereof. The polythiophene compound formed of a PEDOT/PSS compound may be used as the conductive polymer.

For instance, the transparent conductive material may include at least one of a silver nanowire (AgNW), indium tin oxide (ITO), indium zinc oxide (IZO), antimony zinc oxide (AZO), indium tin zinc oxide (ITZO), zinc oxide (ZnO), tin oxide (SnO2), a carbon nanotube, and graphene.

FIGS. 3A and 3B are schematic diagrams illustrating capacitances formed between the sensor electrode and a finger, and between the capacitor electrode and sensor electrode, and the finger when a ridge (FIG. 3A) and a valley (FIG. 3B) of the finger is adjacent to the sensor electrode. FIG. 3A illustrates the case where the ridge 310 of a finger 300 is located on the sensor pixel SP, and FIG. 3B illustrates the case where the valley 320 of the finger 300 is located on the sensor pixel SP.

Referring to FIGS. 3A and 3B, the sensor electrode 240 and the capacitor electrode 250 may form a first capacitor C1. The sensor electrode 240 and the capacitor electrode 250 may be spaced apart from each other, and at least one insulating layer may be interposed therebetween.

When the finger 300 of the user is placed on the sensor pixel SP for fingerprint recognition, the sensor electrode 240 and the finger 300 may form a second capacitor C2. Here, the second capacitor C2 may have a variable capacitance depending on whether the ridge 310 or valley 320 of the fingerprint is placed on the sensor electrode 240.

Since the distance between the ridge 310 and the sensor electrode 240 is shorter than the distance between the valley 320 and the sensor electrode 240, the capacitance of the second capacitor C2 in the case where the ridge 310 is placed on the sensor electrode 240, as shown in FIG. 3A, and the capacitance of the second capacitor C2 in the case where the valley 320 is placed on the sensor electrode 240, as illustrated in FIG. 3B, may differ from each other.

Since a change in the capacitance of the second capacitor C2 influences the output current of the sensor pixel SP, the read-out circuit 120 may recognize the fingerprint of the user by sensing a change in the output current.

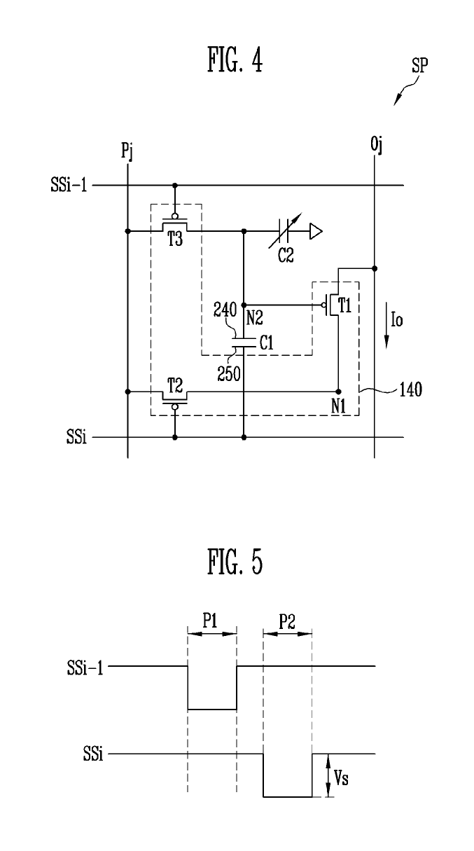

FIG. 4 is an equivalent circuit diagram illustrating an exemplary embodiment of the sensor pixel shown in FIG. 1. FIG. 5 is a timing diagram illustrating exemplary sensor scan signals applied to the sensor pixel shown in FIG. 4.

For the sake of the description, a sensor pixel SP coupled to an i-th sensor scan line SSi, an i-1-th sensor scan line SSi-1, and a j-th output line Oj is shown in FIG. 4. In FIG. 5, a sensor scan signal that is supplied to the i-1-th sensor scan line SSi-1 and a sensor scan signal that is supplied to the i-th sensor scan line SSi are illustrated.

Referring to FIG. 4, the sensor pixel SP may include a first capacitor C1, a first transistor T1, a second transistor T2, and a third transistor T3.

As described above, the first capacitor C1 may be formed by the sensor electrode 240 and the capacitor electrode 250.

The second capacitor C2, which has a variable capacitance, may be formed by the sensor electrode 240 and the finger 300, as described above. Here, the capacitance of the second capacitor C2 may change depending on the distance between the sensor electrode 240 and the finger 300, whether the valley or ridge of a fingerprint is placed on the sensor electrode 240, the magnitude of pressure applied by a touch, or the like.

The first transistor T1 may include a first electrode coupled to a second electrode of the second transistor T2, a second electrode coupled to the j-th output line Oj, and a gate electrode coupled to the sensor electrode 240. In other words, the first transistor T1 may be coupled between the j-th output line Oj and a first node N1, and the gate electrode thereof may be coupled to a second node N2. The first transistor T1 may control an output current Io flowing from the second transistor T2 to the j-th output line Oj depending on a voltage of the second node N2.

The second transistor T2 may include a first electrode coupled to the j-th reference voltage line Pj, a second electrode coupled to the first electrode of the first transistor T1, and a gate electrode coupled to the i-th sensor scan line SSi. In other words, the second transistor T2 may be coupled between the j-th reference voltage line Pj and the first node N1, and the gate electrode thereof may be coupled to the i-th sensor scan line SSi. The second transistor T2 may be turned on when a sensor scan signal is supplied to the i-th sensor scan line SSi. When the second transistor T2 is turned on, a reference voltage Vcom may be applied to the first electrode of the first transistor T1.

The third transistor T3 may include a first electrode coupled to the j-th reference voltage line Pj, a second electrode coupled to the sensor electrode 240, and a gate electrode coupled to the i-1-th sensor scan line SSi-1. In other words, the third transistor T3 may be coupled between the second node N2 and the j-th reference voltage line Pj, and the gate electrode thereof may be coupled to the i-1-th sensor scan line SSi-1.

The third transistor T3 may be turned on when a sensor scan signal is supplied to the i-1-th sensor scan line SSi-1. When the third transistor T3 is turned on, the voltage of the sensor electrode 240 may be initialized to the reference voltage Vcom.

The first capacitor C1 may include the sensor electrode 240 coupled to the second electrode of the third transistor, and the capacitor electrode 250 coupled to the i-th sensor scan line SSi. In other words, the first capacitor C1 may be coupled between the second node N2 and the i-th sensor scan line SSi.

The first node N1 is a node to which the first electrode of the first transistor T1 and the second electrode of the second transistor T2 are coupled in common, and the second node N2 is a node to which the sensor electrode 240, the gate electrode of the first transistor T1, and the second electrode of the third transistor T3 are coupled in common.

The first electrode of each of the transistors T1, T2, and T3 may be any one of a source electrode and a drain electrode, and the second electrode of each of the transistors T1, T2, and T3 may be the other one of the source electrode and the drain electrode. For example, if the first electrode is the source electrode, the second electrode may be the drain electrode.

While the transistors T1, T2, and T3 in the illustrated embodiment are shown as PMOS transistors, the transistors T1, T2, and T3 may be embodied as NMOS transistors.

Referring to FIG. 5, during a first period P1, a sensor scan signal may be supplied to the i-1-th sensor scan line SSi-1. During the first period P1, the third transistor T3 may be turned on in response to the sensor scan signal, and the second node N2 may be initialized to the reference voltage Vcom which is applied from the j-th reference voltage line Pj.

Thereafter, during a second period P2, the sensor scan signal may be supplied to the i-th sensor scan line SSi. During the second period P2, the second transistor T2 may be turned on in response to the sensor scan signal, and the output current Io may flow from the j-th reference voltage line Pj to the j-th output line Oj through the second transistor T2 and the first transistor T1.

Here, the first transistor T1 may control the amount of output current Io in response to a gate voltage which is the voltage of the second node N2. For example, the output current Io may change depending on the gate voltage of the first transistor T1, and the gate voltage of the first transistor T1 may be determined by the following equation.

Vg=Vcom±{Vc1/(Vc1+Vc2)}*Vs

Here, Vg denotes the gate voltage, Vcom denotes the reference voltage, Vc1 denotes the capacitance of the first capacitor C1, Vc2 denotes the capacitance of the second capacitor C2, and Vs denotes a change in the voltage of the sensor scan signal that is supplied to the i-th sensor scan line SSi.

As described above, the read-out circuit 120 may detect the presence or absence of touch, the location of the touch, the pressure of the touch, and/or the fingerprint of a user, using the output current Io received from each of the sensor pixels.

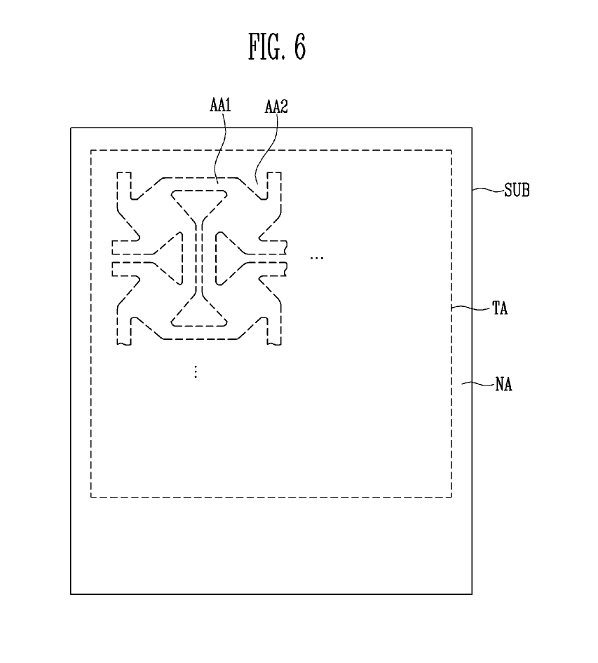

FIG. 6 is a plan view illustrating an exemplary embodiment of a touch sensor including a touch sensing area and a peripheral area constructed according to the principles of the invention.

Referring to FIG. 6, the substrate SUB may be a structure for supporting the sensor pixels SP formed on an upper surface thereof and be elongatable so that it may stretch or shrink in at least one direction.

The substrate SUB may have a shape of a rectangular plate having two pairs of sides that are substantially parallel to each other. In this case, one pair of sides may be longer than the other, but the exemplary embodiments are not limited thereto. The substrate SUB may have various shapes such as a circle and a rectangle having curved corners.

The substrate SUB may include a touch sensing area TA and a peripheral area NA.

Components for driving the sensor pixels SP, such as the sensor scan driver 110, the read-out circuit 120, and the power supply unit 130 shown in FIG. 1, may be disposed in the peripheral area NA. The peripheral area NA may be disposed outside the touch sensing area TA and surround at least some of the touch sensing area TA.

A plurality of sensor pixels SP may be disposed in the touch sensing area TA, whereby a touch of a user in the touch sensing area TA may be sensed.

The touch sensing area TA may include a first area AA1 and a second area AA2.

An island pattern and a bridge pattern of a base layer, which will be described later herein, may be disposed in the first area AA1. Therefore, the shape of the first area AA1 may correspond to that of the island pattern and bridge pattern.

The second area AA2 may be a peripheral area of the first area AA1 and may be formed outside the first area AA1. The second area AA2 may surround the perimeter of the first is area AA1. The base layer may not be provided in the second area AA2.

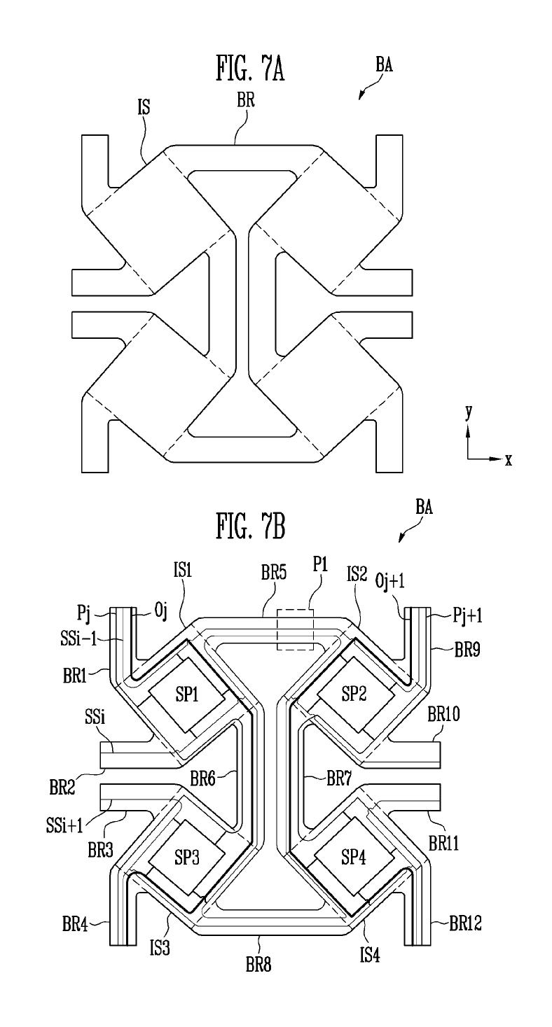

FIGS. 7A and 7B are plan views illustrating an exemplary embodiment of a base layer of a touch sensor shown in FIG. 6.

Referring to FIG. 7A, a base layer BA may be isolated from the remaining structure by having an island shape and itself may include a plurality of island patterns IS and a plurality of bridge patterns BR.

The island patterns IS may be regularly arranged in a first direction (e.g., an x-axis direction) and a second direction (e.g., a y-axis direction). Adjacent island patterns IS may be coupled with each other by the bridge patterns BR.

The sensor pixels SP may be disposed on the island patterns IS. In an exemplary embodiment, a single sensor pixel SP, or a plurality of sensor pixels SP may be disposed on each of the island pattern IS.

The sensor scan lines SS0 to SSn, the output lines O1 to Om, and the reference voltage lines P1 to Pm may be disposed on the island patterns IS and the bridge patterns BR.

The substrate SUB of the touch sensor 100 may be elongatable (or deformable). When the substrate SUB is elongated, the distances between the island patterns IS may be increased or reduced. But, the shape of each of the island patterns IS may remain substantially constant, along with the structure of the sensor pixel SP disposed on each of the island patterns. That is, when the substrate SUB is elongated, each of the island patterns IS may not be increased or reduced in width or height, but the bridge patterns BR coupling the island patterns IS may be deformed.

Referring to FIG. 7B, first to fourth island patterns IS1 to IS4, and first to twelve bridge patterns BR1 to BR12 coupled to the first to fourth island patterns IS1 to IS4 are disposed on the base layer BA.

The first to fourth sensor pixels SP1 to SP4 are respectively disposed on the first to fourth island pattern IS1 to IS4. In FIG. 7, for the sake of explanation, the first to fourth sensor pixels SP1 to SP4 in the illustrated embodiment are shown as being coupled to an i-1-th sensor scan line SSi-1, an i-th sensor scan line SSi, an i+1-th sensor scan line SSi+1, a j-th output line Oj, a j+1-th output line Oj+1, a j-th reference voltage line Pj, and a j+1-th reference voltage line Pj+1. Other arrangements or configurations are possible.

Each island pattern may be coupled to adjacent bridge patterns, and the island patterns may be coupled to each other through the bridge patterns.

For example, a first side of the first island pattern IS1 may be coupled to the first bridge pattern BR1, a second side thereof may be coupled to the second bridge pattern BR2, a third side thereof may be coupled to the sixth bridge pattern BR6, and a fourth side thereof may be coupled to the fifth bridge pattern BR5.

For example, a first side of the second island pattern IS2 may be coupled to the fifth bridge pattern BR5, a second side thereof may be coupled to the seventh bridge pattern BR7, a third side thereof may be coupled to the tenth bridge pattern BRIO, and a fourth side thereof may be coupled to the ninth bridge pattern BR9.

For example, a first side of the third island pattern IS3 may be coupled to the third bridge pattern BR3, a second side thereof may be coupled to the fourth bridge pattern BR4, a third side thereof may be coupled to the eighth bridge pattern BR8, and a fourth side thereof may be coupled to the sixth bridge pattern BR6.

For example, a first side of the fourth island pattern IS4 may be coupled to the seventh bridge pattern BR7, a second side thereof may be coupled to the eighth bridge pattern BR8, a third side thereof may be coupled to the twelfth bridge pattern BR12, and a fourth side thereof may be coupled to the eleventh bridge pattern BR11.

In detail, the first island pattern IS1 may be coupled to the second island pattern IS2 through the fifth bridge pattern BR5, and be coupled to the third island pattern IS3 through the sixth bridge pattern BR6.

The fourth island pattern IS4 may be coupled to the second island pattern IS2 through the seventh bridge pattern BR7, and be coupled to the third island pattern IS3 through the eighth bridge pattern BR8.

The sensor pixels SP disposed in the same row may be coupled to the same sensor scan lines. In detail, the sensor pixels SP disposed in the same row may receive sensor scan signals from the sensor scan driver 110 through the same sensor scan lines. For instance, each of the first and second sensor pixels SP1 and SP2 may be coupled to the i-1-th sensor scan line SSi-1 and the i-th sensor scan line SSi. Each of the third and fourth sensor pixels SP3 and SP4 may be coupled to the i-th sensor scan line SSi and the i+1-th sensor scan line SSi+1.

The i-1-th sensor scan line SSi-1 may be disposed on the first bridge pattern BR1, the fifth bridge pattern BR5, and the ninth bridge pattern BR9, and be disposed on the first and second island patterns IS1 and IS2.

The i-th sensor scan line SSi may be disposed on the second bridge pattern BR2, the fifth bridge pattern BR5, the sixth bridge pattern BR6, the seventh bridge pattern BR7, the eighth bridge pattern BR8 and the tenth bridge pattern 10, and be disposed on the first to fourth island patterns IS1 to IS4.

The i+1-th sensor scan line SSi+1 may be disposed on the third bridge pattern BR3, the fourth bridge pattern BR4, the eighth bridge pattern BR8, the eleventh bridge pattern BR11 and the twelfth bridge pattern BR12, and be disposed on the third and fourth island patterns IS3 and IS4.

The sensor pixels SP disposed in the same column may be coupled to the same output line and the same reference voltage line. In detail, the sensor pixels SP disposed in the same column may be supplied with the reference voltage Vcom from the power supply unit 130 through the same reference voltage line, and may output the output current Io to the read-out circuit 120 through the same output line. For example, each of the first and third sensor pixels SP1 and SP3 may be coupled to the j-th output line Oj and the j-th reference voltage line Pj. Each of the second and fourth sensor pixels SP2 and SP4 may be coupled to the j+1-th output line Oj+1 and the j+1-th reference voltage line Pj+1.

The j-th output line Oj and the j-th reference voltage line Pj may be disposed on the first bridge pattern BR1, the fourth bridge pattern BR4, and the sixth bridge pattern BR6, and may be also disposed on the first island pattern IS1 and the third island pattern IS3.

The j+1-th output line 0j+1 and the j+1-th reference voltage line Pj+1 may be disposed on the seventh bridge pattern BR7, the ninth bridge pattern BR9, and the twelfth bridge pattern BR12, and be disposed on the second and fourth island patterns IS2 and IS4.

While each of the island patterns IS in the illustrated embodiment is shown as having a substantially rectangular shape, exemplary embodiments of the island patterns IS are not limited thereto, and the shapes of the island patterns IS may be variously changed. In addition, the shapes of the bridge patterns BR may also be changed variously without being limited to those illustrated in FIGS. 7A and 7B.

While each of the island patterns IS in the illustrated embodiment is shown as being coupled to four bridge patterns, exemplary embodiments are not limited thereto. The number of bridge patterns BR coupled to each island pattern may be variously changed.

While the first to fourth sensor pixels SP1 to SP4 in the illustrated embodiment are shown as disposed on the first to fourth island patterns IS1 to IS4, respectively, the exemplary embodiments are not limited thereto. For instance, a plurality of sensor pixels SP may be disposed on each of the island patterns IS. Furthermore, the number of signal lines may be variously changed depending on the number of sensor pixels SP disposed on each of the island patterns IS.

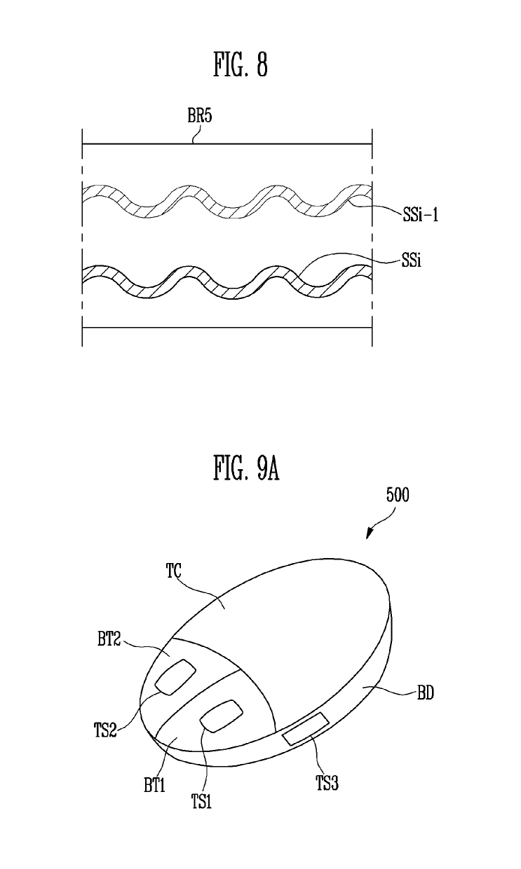

FIG. 8 is an enlarged view of a region P1 shown in FIG. 7B.

Referring to FIG. 8, the i-1-th sensor scan line SSi-1 and i-th sensor scan line SSi may have a shape that accommodates deformation or elongation, such as the wavy shapes on the fifth bridge pattern BR5 formed by alternating concave and convex portions, as described subsequently.

The bridge pattern BR may be elongatable (or deformable) so that it may stretch or shrink in at least one direction. Stress is imposed on the i-1-th sensor scan line SSi-1 and i-th sensor scan line SSi when the fifth bridge pattern BR5 stretches or shrinks, since the i-1-th sensor scan line SSi-1 and the i-th sensor scan line SSi are disposed in the fifth bridge pattern BR5. When the i-1-th sensor scan line SSi-1 and the i-th sensor scan line SSi are subject to stress they can deform, thereby creating the probability of disconnection of the i-1-th sensor scan line SSi-1 and the i-th sensor scan line SSi.

However, in accordance with the principles of the invention, portions of signal lines disposed in the bridge patterns BR may include slack or have shapes, such as the alternating convex and concave curved shapes shown in FIG. 8, that accommodate for stress causing changes in the size or shape of the bridge patterns. In this case, even when stress due to deformation is applied to the portions of the signal lines, the portions of the signal lines may be easily deformed due to slack or shapes of the signal lines without causing line defects such as disconnection. Consequently, the defects in signal lines that can occur when the touch sensor 100 and/or the bridge patterns BR are deformed may be effectively reduced or prevented. Thus, the touch sensor 100 may sense a fingerprint effectively.

While the i-1-th sensor scan line SSi-1 and the i-th sensor scan line SSi disposed on the fifth bridge pattern BR5 are shown in FIG. 8 as an example, exemplary embodiments are not limited thereto. The signal lines, such as the sensor scan lines SS0 to SSn, the output lines O1 to Om, and the reference voltage lines P1 to Pm, may include portions having slack or curved shapes on the bridge patterns BR.

When the bridge patterns are deformed, each island pattern may not be substantially deformed. The scan lines SS0 to SSn, the output lines O1 to Om, and the reference voltage lines P1 to Pm that are disposed on the island patterns IS may have conventional linear shapes without slack or curves. However, exemplary embodiments are not limited thereto, each of the scan lines SS0 to SSn, the output lines O1 to Om, and the reference voltage lines P1 to Pm that are disposed on the island patterns IS may have slack or curve shapes.

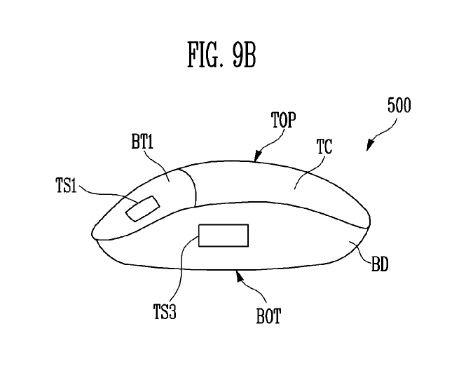

FIG. 9A is a perspective view illustrating an exemplary embodiment of a mouse including a touch sensor constructed according to the principles of the invention. FIG. 9B is a side view illustrating the mouse shown in FIG. 9A.

Referring to FIGS. 9A and 9B, a mouse 500 may include a body BD, a top cover TC which is disposed on the body BD and supports the hand of a user, first and second button units BT1 and BT2 which are clicked by the fingers of the user.

The mouse 500 may be an input device which is grasped by the hand of the user and configured to receive a command from the user. The mouse 500 may be coupled to a device such as a computer and may perform wired or wireless communication with the device.

Although not shown in FIGS. 9A and 9B, a rolling ball for sensing movement of the mouse may be disposed in a bottom surface BOT of the body BD. The mouse 500 may have a sensor in the bottom surface BOT of the body BD, and recognize movement of the body BD by the sensor.

The bottom surface BOT of the body BD may have a planar shape such that it is supported on an upper surface of a desk or a support surface. The top cover TC may have a rounded top surface TOP, a portion of which protrudes upward so that the top surface TOP is wrapped by the palm of the user.

Each of the first and second button units BT1 and BT2 may be formed in a curved shape having a predetermined curvature, corresponding to the round shape of the top cover TC, when viewed in a side view.

The mouse 500 may include first to third touch sensors TS1 to TS3 each of which is configured to sense a fingerprint.

For example, the first touch sensor TS1 may be disposed in or on the first button unit BT1, the second touch sensor TS2 may be disposed in or on the second button unit BT2, and the third touch sensor TS3 may be disposed in or on a side surface of the body BD.

Each of the first and second button units BT1 and BT2, and the side surface of the body BD may have a predetermined curvature. In response, each of the first to third touch sensors TS1 to TS3 may have a curved shape having a predetermined curvature.

Each of the first to third touch sensors TS1 to TS3 may be embodied as the touch sensor 100 illustrated in FIGS. 1 to 8. Since the first to third touch sensors TS1 to TS3 are elongatable (or deformable) without causing defects, the first to third touch sensors TS1 to TS3 may be disposed in or on the first button unit BT1, the second button unit BT2, and the side surface of the body BD, which may have ergonomic shapes including curvatures. Therefore, the fingers of the user may contact the first to third sensors TS1 to TS3 properly, and the first to third touch sensors TS1 to TS3 may sense the fingerprints of the user effectively.

The mouse 500 may perform a security function using the first to third touch sensors TS1 to TS3. For example, a computer coupled to the mouse 500 may periodically request the mouse 500 to perform fingerprint recognition, and may restrict or allow the use of the mouse 500 depending on the result of the fingerprint recognition. In detail, depending on the result of the fingerprint recognition, the computer may allow an authorized user to use the mouse 500, or not allow an unauthorized user to use the mouse 500.

The mouse 500 in the illustrated embodiment is shown as having three touch sensors TS1 to TS3, but exemplary embodiments are not limited thereto. The number of touch sensors may be variously changed. Further, the position and the shape of each touch sensor may also be variously changed.

Touch sensors constructed according the principles of the invention may have an elongatable structure using island patterns and bridge patterns, and be configured to sense a fingerprint using sensor pixels disposed on the island patterns, and the touch sensors may be incorporated in a mouse.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements.

What is claimed is:

1. A touch sensor comprising:
a substrate;
a base layer having first patterns arranged on the substrate and second patterns coupled between the first patterns; and
sensor pixels disposed on the first patterns and configured to sense a touch of a user depending on a change in capacitance associated with a corresponding sensor pixel.

2. The touch sensor of claim 1, further comprising sensor scan lines and output lines coupled to the sensor pixels,
wherein, among the sensor pixels, a sensor pixel coupled to an i-th sensor scan line selected from the scan lines and a j-th output line selected from the output lines comprises:
a sensor electrode;
a first transistor having a gate electrode coupled to the sensor electrode, the first transistor being configured to control output current to be outputted through the j-th output line;
a second transistor having a gate electrode coupled to the i-th sensor scan line, the second transistor being coupled between a reference voltage line and the first transistor; and
a capacitor electrode configured to form a first capacitor with the sensor electrode, and coupled to the i-th sensor scan line, wherein i is an integer equal to or greater than 2 and j is a natural number.

3. The touch sensor of claim 2, wherein the sensor pixel further comprises:
a third transistor having a gate electrode coupled to an i-1-th scan line, the third transistor being coupled between the reference voltage line and the sensor electrode.

4. The touch sensor of claim 2, wherein the sensor electrode forms a second capacitor with a finger of the user.

5. The touch sensor of claim 4, wherein the magnitude of the output current varies depending on a change in capacitance of the second capacitor.

6. The touch sensor of claim 4, wherein a gate voltage to be applied to the gate electrode of the first transistor is defined by a following equation,
Vg=Vcom+Vc1/(Vc1+Vc2)*Vs,
where Vg denotes the gate voltage, Vcom denotes a reference voltage provided to the second transistor through the reference voltage line, Vc1 denotes a capacitance of the first capacitor, Vc2 denotes a capacitance of the second capacitor, and Vs denotes a change in voltage of a sensor scan signal provided through the i-th sensor scan line.

7. The touch sensor of claim 2, further comprising:
a power supply unit configured to provide a reference voltage to the reference voltage line;
a sensor scan driver configured to successively supply a sensor scan signal to the sensor scan lines; and
a read-out circuit configured to detect a fingerprint using output current provided through the output lines.

8. The touch sensor of claim 7, wherein:
the substrate includes a touch sensing area and a peripheral area disposed around the touch sensing area;
the base layer is disposed on the touch sensing area; and
at least one of the power supply unit, the sensor scan driver and the read-out circuit is disposed on the peripheral area.

9. The touch sensor of claim 2, wherein the sensor electrode comprises a transparent conductive material.

10. The touch sensor of claim 2, wherein the sensor electrode overlaps the capacitor electrode in a plan view.

11. The touch sensor of claim 1, further comprising signal lines coupled to the sensor pixels,
wherein the sensor pixels are controlled through the signal lines, and
wherein the signal lines are disposed in the second patterns, and extend into the first patterns coupled to the sensor pixels.

12. The touch sensor of claim 11, wherein portions of the signal lines disposed in the second patterns have a shape that accommodates deformation without creating defects in the signal lines.

13. The touch sensor of claim 12, wherein the shape of the portions of the signal lines disposed in the second patterns comprises a shape having slack or curvature, and at least portions of the signal lines disposed in the first patterns have linear shapes.

14. The touch sensor of claim 1, wherein the first patterns comprise island patterns and the second patterns comprise bridge patterns.

15. A computer mouse comprising:
a body;
at least one button unit disposed on the body and configured to receive an input from a user; and
a touch sensor configured to sense a touch of the user to generate touch information, wherein the touch sensor comprises:
a substrate;
a base layer comprising first patterns arranged on the substrate and second patterns coupled between the first patterns; and
sensor pixels disposed on the first patterns configured to sense the touch of the user depending on a change in capacitance associated with a corresponding sensor pixel.

16. The computer mouse of claim 15, wherein:
the touch sensor further comprises sensor scan lines and output lines coupled to the sensor pixels; and
among the sensor pixels, a sensor pixel coupled to an i-th sensor scan line selected from the scan lines and a j-th output line selected from the output lines comprises:
a sensor electrode;
a first transistor having a gate electrode coupled to the sensor electrode, the first transistor being configured to control output current to be outputted through the j -th output line;
a second transistor having a gate electrode coupled to the i-th sensor scan line, the second transistor being coupled between a reference voltage line and the first transistor; and
a capacitor electrode configured to form a first capacitor with the sensor electrode, and coupled to the i-th sensor scan line, wherein i is an integer equal to or greater than 2 and j is a natural number.

17. The computer mouse of claim 16, wherein the sensor pixel further comprises:
a third transistor having a gate electrode coupled to an i-1-th scan line, the third transistor being coupled between the reference voltage line and the sensor electrode.

18. The computer mouse of claim 16, wherein:
the sensor electrode forms a second capacitor with a finger of the user; and
a magnitude of the output current varies depending on a change in capacitance of the second capacitor.

19. The computer mouse of claim 16, wherein the touch sensor further comprises:
a power supply unit configured to provide a reference voltage to the reference voltage line;
a sensor scan driver configured to successively supply a sensor scan signal to the sensor scan lines; and
a read-out circuit configured to detect a fingerprint using the output current provided through the output lines.

20. The computer mouse of claim 15, wherein the touch sensor is disposed in or on at least one of the body and the at least one button unit, and the first patterns comprise island patterns and the second patterns comprise bridge patterns.
